(19) United States
(12) Patent Application Publication
(10) Pub. No.: US 2006/0120713 A1
(43) Pub. Date: Jun. 8, 2006

(54) Semiautomatic cover-sliding structure

(76) Inventors: Men-Sheng Wang, Taoyuan (TW); Kai-Chung Hou, Taoyuan (TW)

Correspondence Address: Hoffman, Warnick & D'Alessandro LLC, 14th Floor, 75 State Street, Albany, NY, 12207, US

(21) Appl. No.: 11/292,015

(22) Filed: Dec. 1, 2005

(30) Foreign Application Priority Data
Dec. 3, 2004 (TW) 093137417

(51) Int. Cl. G03B 17/04

(52) U.S. Cl. 396/349

(57) ABSTRACT

A semiautomatic cover-sliding structure including a main body, a cover, and an auxiliary device is provided. A first surface of the main body includes a trench. The cover includes a clasp corresponding to the trench for sliding the cover on the first surface of the main body. The auxiliary device is disposed between the main body and the cover. The auxiliary device includes a first fixing end attached to the main body and a second fixing end attached to the cover. The auxiliary device assists the cover to slide along a first predetermined direction with a recovering force.

### BACKGROUND OF THE INVENTION

1. Field of the Invention

This invention relates to a cover-sliding structure, and more specifically, a semiautomatic cover-sliding structure.

2. Description of the Prior Art

Current mobile phones can be classified into various types, for example, bar type, slide type, and flip type, according to different appearances. Compared with bar type mobile phones, slide type mobile phones are smaller and have larger keypads. Hence, slide type mobile phones are usually more convenient and popular than bar type mobile phones.

The covers of general slide type mobile phones are mostly opened or closed in a manual manner. However, female users or users of smaller palms might not open or close the covers completely and smoothly. Accordingly, the main purpose of this invention is providing a semiautomatic cover-sliding structure to overcome the aforementioned problem.

### SUMMARY OF THE INVENTION

One main purpose of this invention is to provide a semiautomatic cover-sliding structure. In this structure, an auxiliary device is used to provide recovering force that can aid the opening/closing of the cover-sliding.

This invention provides a semiautomatic cover-sliding structure including a main body, a cover, and an auxiliary device. A first surface of the main body includes a trench. The cover includes a clasp corresponding to the trench for sliding the cover on the first surface of the main body. The auxiliary device is disposed between the main body and the cover. The auxiliary device includes a first fixing end attached to the main body and a second fixing end attached to the cover. The auxiliary device assists the cover to slide along a first predetermined direction with a recovering force.

The semiautomatic cover-sliding structure according to this invention uses the auxiliary device connected between the main body and the cover for assisting the cover to slide along a first predetermined direction. With the auxiliary device, the semiautomatic cover-sliding structure according to this invention provides a more convenient way for users to open or close the cover.

The advantage and spirit of the invention may be understood by the following recitations together with the appended drawings.

### BRIEF DESCRIPTION OF THE APPENDED DRAWINGS

FIG. 1 shows a semiautomatic cover-sliding structure of one embodiment according to this invention.

FIG. 2 shows the position of the auxiliary device of the semiautomatic cover-sliding structure.

FIG. 3 shows the condition when the auxiliary device is at the threshold position.

FIG. 4A shows how the auxiliary device assists to open the cover.

FIG. 4B shows how the auxiliary device assists to close the cover.

FIG. 5 shows a semiautomatic cover-sliding structure of the other embodiment according to this invention.

FIG. 6 shows a semiautomatic cover-sliding structure of another embodiment according to this invention.

### DETAILED DESCRIPTION OF THE INVENTION

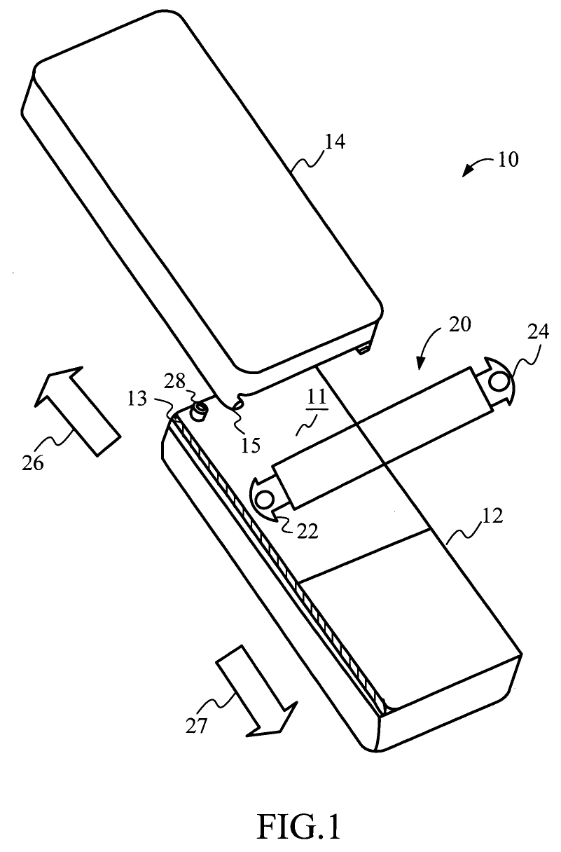

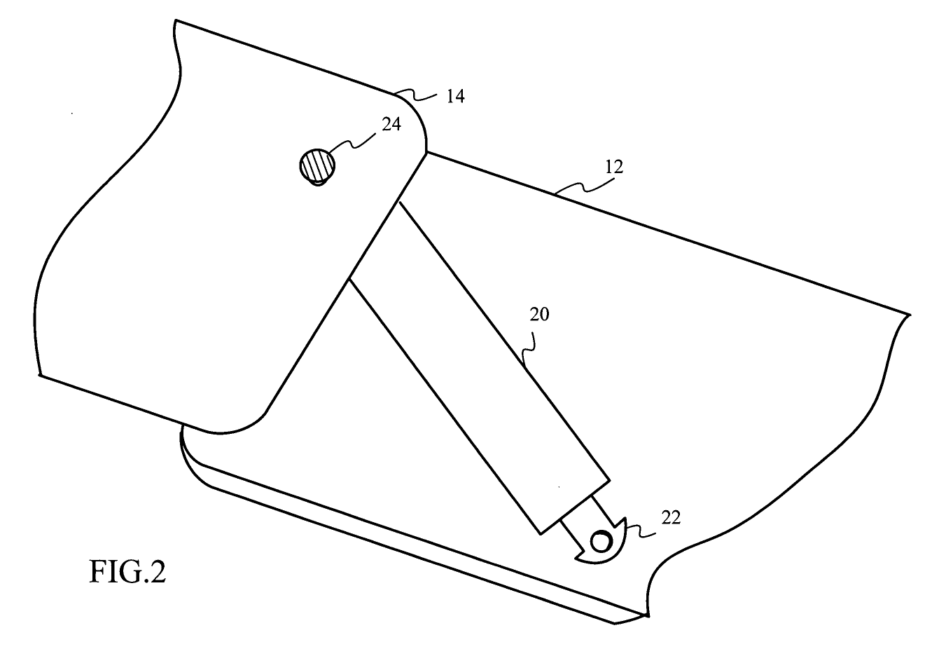

Please refer to FIG. 1 and FIG. 2. FIG. 1 shows a semiautomatic cover-sliding structure 10 of one embodiment according to this invention. As shown in FIG. 1, the semiautomatic cover-sliding structure 10 includes a main body 12, a cover 14, and an auxiliary device 20. FIG. 2 shows the position of the auxiliary device 20. A first surface 11 of the main body 12 includes a trench 13. The first surface 11 of the main body 12 is the surface which is most near to a cover 14. The cover 14 includes a clasp 15 corresponding to the trench 13. The clasp 15 is used for engaging the cover 14 with the first surface 11 of the main body 12.

The auxiliary device 20 is disposed between the main body 12 and the cover 14. The auxiliary device 20 includes a first fixing end 22 attached to the main body 12 and a second fixing end 24 attached to the cover 14. The auxiliary device 20 assists the cover 14 to slide along a first predetermined direction with a recovering force. The auxiliary device 20 is compressible and has a threshold position at which the auxiliary device 20 has a maximum compressing potential energy. The threshold position is where the auxiliary device 20 is substantially perpendicular to the first predetermined direction. When the cover 14 slides so that the auxiliary device 20 is away from the threshold position, the auxiliary device 20 further actuates the cover 14 to slide in the first predetermined direction.

In some applications, the first predetermined direction is parallel to the first surface 11 and the direction in which the cover 14 moves away from the main body 12. In other applications, the first predetermined direction is parallel to the first surface 1 and the direction in which the cover 14 moves close to the main body 12. In the embodiment shown in FIG. 1, the arrow 26 shows the first predetermined direction, wherein the first predetermined direction is the direction in which the cover 14 been opened along the trench 13 on the first surface 11. In other embodiments, the first predetermined direction can also be the direction as shown by the arrow 27.

The semiautomatic cover-sliding structure 10 can further include a stopping column 28 for stopping the movement of the cover 14 when the cover 14 slides to a predetermined position. As shown in FIG. 1, the stopping column 28 is disposed near the end of the trench 13 for preventing the cover 14 from departing from the main body 12; thus, the function of the stopping column 28 is to stop the movement of the cover 14 at the predetermined position.

As shown in FIG. 2, the first fixing end 22 of the auxiliary device 20 is affixed to the main body 12 and the second fixing end 24 of the auxiliary device 20 is affixed to the cover 14. The first fixing end 22 and the second fixing end 24 not only assist the movement of the cover 14, but also can stop the movement of the cover 14 at the predetermined position.

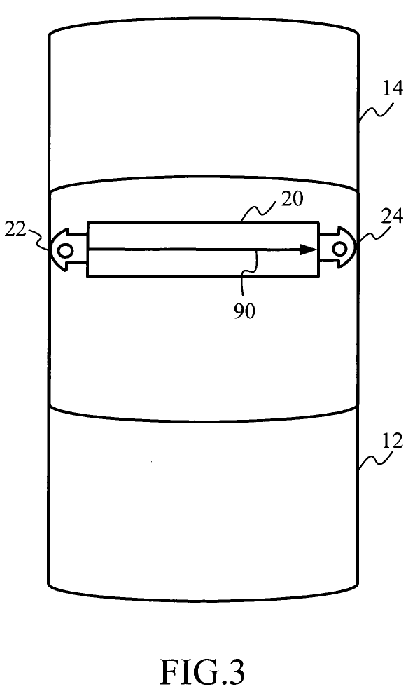

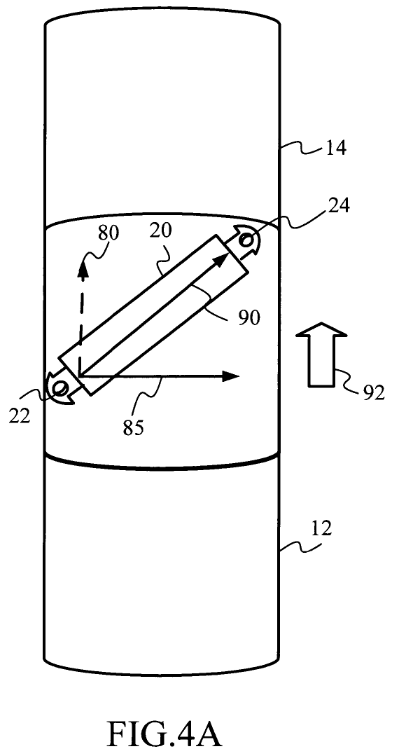

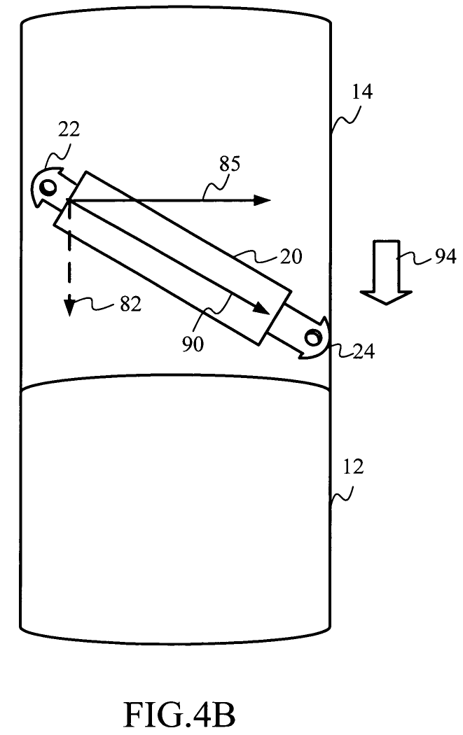

Please refer to FIG. 3, FIG. 4A, and FIG. 4B. FIG. 3 shows the condition when the auxiliary device 20 is at the threshold position. FIG. 4A shows how the auxiliary device assists to open the cover. FIG. 4B shows how the auxiliary device assists to close the cover. The auxiliary device 20 in this embodiment includes a spring. The first fixing end 22 of the spring is affixed to the main body 12 and the second fixing end 24 of the spring is affixed to the cover 14. A threshold position is where the auxiliary device 20 is substantially perpendicular to the first predetermined direction or where the auxiliary device 20 is substantially parallel to the cover 14. The spring has a maximum compressing potential energy at the threshold position because the spring is compressed and limited by the main body 12 and the cover 14. When a user opens or closes the cover 14, as shown in FIG. 3, FIG. 4A, and FIG. 4B, the auxiliary device 20 leaves the threshold position and the spring is escaped from the limitation of the main body 12 such that the spring obtains a outward recovering force to move the cover 14. Accordingly, the spring can assist the cover 14 to slide along the main body 12 since the spring tends to stretch from the threshold position where the spring has a maximum compressing potential energy to another position where the spring has a smaller compressing potential energy.

The operation of the auxiliary device is explained below. As shown in FIG. 4A, when a user opens the cover 14 in the direction as the arrow 92 shows, a force is provided to the auxiliary device 20 in the same direction as the arrow 92 shows. When the auxiliary device 20 is moved over the threshold position (not shown in FIG. 4A), the auxiliary device 20 is driven to the position where the spring has a smaller compressing potential energy. The compression force of the spring generated at the threshold position is the recovering force of the auxiliary device 20. With the recovering force, the auxiliary device 20 assists the cover 14 to slide along the direction as the arrow 92 shows until the cover 14 is completely opened.

On the contrary, as shown in FIG. 4B, when a user closes the cover 14 in the direction as the arrow 94 shows, a force is provided to the auxiliary device 20 in the same direction as the arrow 94 shows. When the auxiliary device 20 moves over the threshold position (not shown in FIG. 4B), the auxiliary device 20 is driven to the position where the spring has a smaller compressing potential energy. The compression force of the spring generated at the threshold position is the recovering force of the auxiliary device 20. With the recovering force, the auxiliary device 20 assists the cover 14 to slide along the direction as the arrow 94 shows until the cover 14 is completely closed.

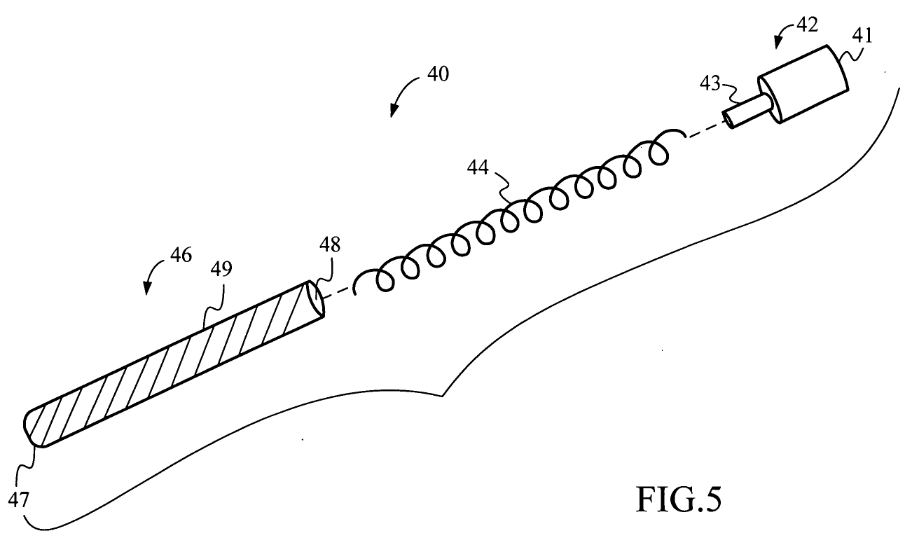

Please refer to FIG. 5. FIG. 5 shows an auxiliary device 20 of the other embodiment according to this invention. In this embodiment, the auxiliary device 20 is a probe including a probe head 42, a spring 44, and a probe body 46. The probe head includes a first fixing end 41 and a column 43 affixed to the first fixing end 41. The probe head 42 is affixed to the main body 12 by the first fixing end 41. The spring 44 is affixed to the column 43 of the probe head 42. The probe body 46 includes a second fixing end 47 of the auxiliary device 20, an opening end 48, and a casing 49. The probe body 46 is affixed to the cover 14 by the second fixing end 47. A hollow space is formed by the casing 49 to accommodate the probe head 42 and the spring 44 such that the spring 44 is disposed between the probe body 46 and the probe head 42. In this embodiment, the spring 44 is disposed inside the probe body 46 so that the spring 44 can be constrained by the casing 49 for a better stability.

In another embodiment, the auxiliary device is a probe including a probe head, a spring, and a probe body. The probe head includes a second fixing end and a column affixed to the second fixing end. The spring is affixed to the column of the probe head. The probe body includes the first fixing end and an open end for accommodating the probe head and the spring such that the spring is positioned between the probe body and the probe head. This embodiment is different from the prior embodiment since the probe head is affixed to the cover and the probe body is affixed to the main body; the affixed positions of the probe head and the probe body is contrary to those in the prior embodiment. The auxiliary device according to this invention in this embodiment is only needed to be affixed between the main body and the cover; the connection relationship between the first fixing end, the second fixing end, the main body, and the cover is not limited in the aforementioned embodiments.

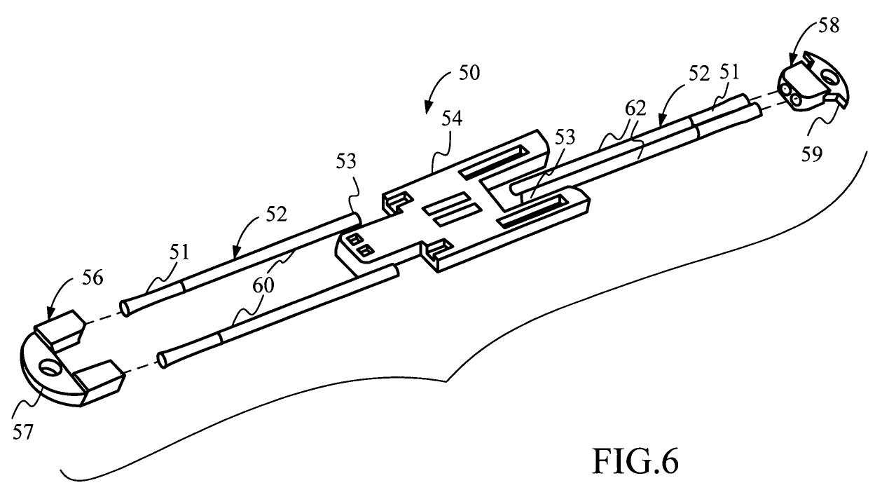

Please refer to FIG. 6. FIG. 6 shows a semiautomatic cover-sliding structure of another embodiment according to this invention. In this embodiment, the auxiliary device 50 includes a plurality of probes 52, a sleeve 54, a first fixing base 56, and a second fixing base 58. The plurality of probes 52 includes a first set of probes 60 and a second set of probes 62. Each probe includes a first end 51 and a second end 53, and the plurality of probes 52 assist the cover 14 to slide in the first predetermined direction with an elastic force. Each first end 51 is affixed on the first fixing base 56 and the second fixing base 58. As shown in FIG. 5, each probe 40 of the plural probes 52 includes a probe head 42, a spring 44, and a probe body 46. The probe head 42 includes a first end 41 and a column 43 affixed to the first end 41. The spring 44 is affixed to the column 43 on the probe head 42. The probe body 46 includes a second end 47 and an open end 48 for accommodating the probe head 41 and the spring 44 such that the spring 44 is positioned between the probe body 46 and the probe head 41.

The sleeve 54 engages with the second end 53 of each probe among the plural probes 52. The first fixing base 56 includes the first fixing end 57 for affixing the first fixing base 56 to the main body 12 and is engaged with the first end 51 of each probe among the first set of probes 60. The second fixing base 58 includes the second fixing end 59 for affixing the second fixing base 58 to the cover 14 and is engaged with the first end 51 of each probe among the second set of probes 62. In this embodiment, the first set of probes 60 and the second set of probes 62 are crossed with each other and assembled inversely in the sleeve 54; thus, the auxiliary device has better stability. Besides, the stretching length of the spring 44 is doubled without adding the length of the probes 52.

In another embodiment according to this invention, the auxiliary device includes a plurality of probe heads including a first set of probe heads and a second set of probe heads, a plurality of springs, a sleeve, a first fixing base, and a second fixing base. Each probe head includes a first end and a column. The plurality of springs is corresponding to the plurality of probe heads, wherein each spring is affixed to the column of the corresponding probe head. The sleeve is used for accommodating the plural springs and the plural columns, wherein the plurality of springs are disposed between the columns and the sleeve. The first fixing base includes the first fixing end for affixing the first fixing base to the main body and the first fixing base is used for engaging with the first end of each probe head. The second fixing base includes the second fixing end for affixing the second fixing base to the cover and the second fixing base is used for engaging with the first end of each probe head. In this embodiment, the spring is disposed in the sleeve and the columns are used for compressing the spring. In the last embodiment, the spring for assisting to open or close the cover is accommodated in the probe.

The semiautomatic cover-sliding structure can be applied to a slide type mobile phone, wherein the main body of the semiautomatic cover-sliding structure is equivalent to the main body of the mobile phone and the cover of the semiautomatic cover-sliding structure is equivalent to the cover of the mobile phone. When a user provides a force to open the cover and the auxiliary device slides over a threshold position, the auxiliary device assists to open the cover to a predetermined position with the recovering force of the spring. Similarly, when wanting to close the cover, the user only needs to slide the cover such that the auxiliary device is over the threshold position, and then the auxiliary device will assist to close the cover with the recovering force of the spring. Accordingly, it is convenient for users to open or close a cover of a slide type mobile phone with the semiautomatic cover-sliding structure according to this invention. With the examples and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A semiautomatic cover-sliding structure comprising:
a main body with a first surface comprising a trench;
a cover comprising a clasp corresponding to the trench, the clasp being used for sliding the cover on the first surface of the main body; and
an auxiliary device disposed between the main body and the cover, the auxiliary device comprising a first fixing end attached to the main body and a second fixing end attached to the cover, the auxiliary device assisting the cover to slide along a first predetermined direction with a recovering force.

2. The semiautomatic cover-sliding structure of claim 1, wherein the first predetermined direction is parallel to the first surface, and the first predetermined direction is also the direction in which the cover is capable of moving away from the main body.

3. The semiautomatic cover-sliding structure of claim 1, wherein the first predetermined direction is parallel to the first surface, and the first predetermined direction is also the direction in which the cover is capable of moving close to the main body.

4. The semiautomatic cover-sliding structure of claim 1, wherein the auxiliary device is compressible and has a threshold position at which the auxiliary device has a maximum compressing potential energy.

5. The semiautomatic cover-sliding structure of claim 4, wherein the threshold position is where the auxiliary device is substantially perpendicular to the first predetermined direction.

6. The semiautomatic cover-sliding structure of claim 4, wherein when the cover is slid so that the auxiliary device is away from the threshold position, the auxiliary device further actuates the cover to slide in the first predetermined direction.

7. The semiautomatic cover-sliding structure of claim 1, wherein the auxiliary device comprises a spring.

8. The semiautomatic cover-sliding structure of claim 1, wherein the auxiliary device has a probe comprising:
a probe head comprising the first fixing end and a column affixed to the first fixing end;
a spring affixed to the column of the probe head; and
a probe body comprising the second fixing end and an open end for accommodating the probe head and the spring such that the spring is positioned between the probe body and the probe head.

9. The semiautomatic cover-sliding structure of claim 8, wherein the probe body comprises a casing so that a hollow space is formed by the casing and the open end to accommodate the probe head and the spring.

10. The semiautomatic cover-sliding structure of claim 1, wherein the auxiliary device is a probe comprising:
a probe head comprising the second fixing end and a column affixed to the second fixing end;
a spring affixed to the column of the probe head; and
a probe body comprising the first fixing end and an open end for accommodating the probe head and the spring such that the spring is positioned between the probe body and the probe head.

11. The semiautomatic cover-sliding structure of claim 10, wherein the probe body comprises a casing so that a hollow space is formed by the casing and the open end to accommodate the probe head and the spring.

12. The semiautomatic cover-sliding structure of claim 1, wherein the auxiliary device comprises:
a plurality of probes comprising a first set of probes and a second set of probes, each probe comprising a first end and a second end, and the plurality of probes assisting the cover to slide along the main body in the first predetermined direction with an elastic force;
a sleeve engaging with the second end of each probe of the plural probes;
a first fixing base comprising the first fixing end for affixing the first fixing base to the main body, the first fixing base being used for engaging with the first end of each probe of the first set of probes; and
a second fixing base comprising the second fixing end for affixing the second fixing base to the cover, the second fixing base being used for engaging with the first end of each probe of the second set of probes.

13. The semiautomatic cover-sliding structure of claim 11, wherein each probe comprises:
a probe head comprising the first fixing end and a column affixed to the first fixing end;
a spring affixed to the column of the probe head; and
a probe body comprising the second fixing end and an open end for accommodating the probe head and the spring such that the spring is positioned between the probe body and the probe head.

14. The semiautomatic cover-sliding structure of claim 1, wherein the auxiliary device comprises:
a plurality of probe heads comprising a first set of probe heads and a second set of probe heads and each probe head comprising a first end and a column;
a plurality of springs corresponding to the plurality of probe heads, wherein each spring is affixed to the column of the corresponding probe head;
a sleeve for accommodating the plurality of springs and the plurality of columns, wherein the plurality of springs are positioned between the plurality of columns and the sleeve;
a first fixing base comprising the first fixing end for affixing the first fixing base to the main body, the first fixing base being used for engaging with the first end of each probe head of the first set of probe heads; and
a second fixing base comprising the second fixing end for affixing the second fixing base to the cover, the second fixing base being used for engaging with the first end of each probe head of the second set of probe heads.

15. The semiautomatic cover-sliding structure of claim 1, wherein the main body comprises a stopping column for stopping the movement of the cover when the cover slides to a predetermined position.
